(19) United States
(12) Patent Application Publication
(10) Pub. No.: US 2019/0041690 A1
(43) Pub. Date: Feb. 7, 2019

(54) COLOR FILTER AND DISPLAY PANEL

(71) Applicant: SHENZHEN CHINA STAR OPTOELECTRONICS TECHNOLOGY CO., LTD., Shenzhen, Guangdong (CN)

(72) Inventor: Zhongjie LIU, Shenzhen (CN)

(21) Appl. No.: 15/574,276

(22) PCT Filed: Aug. 14, 2017
(86) PCT No.: PCT/CN2017/097323

§ 371 Date: Nov. 15, 2017

(30) Foreign Application Priority Data
Aug. 2, 2017 (CN) 201710650473.X

(51) Int. Cl. G02F 1/1335

(52) U.S. Cl. CPC G02F 1/133514; G02F 1/1337; G02F 1/133512

(57) ABSTRACT

A color filter is provided, which includes a plurality of color filter units arranged in an array. Each color filter unit includes a display and light filtering region, a non-display and lateral light shielding region, and a non-display and longitudinal light shielding region, where an opening of photoresist layer in the overlapping region is formed on at least one side of the non-display and longitudinal light filtering region of the color filter unit for decreasing an area of the non-display and longitudinal light shielding region of two color-filter photoresist layers. A display panel is also provided.

### FIELD OF DISCLOSURE

The present disclosure relates to the field of displays, and more particularly to a color filter and a display panel.

### BACKGROUND

With development of display panel technology, users have higher requirements for display panels. As resolution of display panels increases, size of pixel units of the display panels is decreasing.

FIG. 1 is a structural diagram of a color filter of a display panel in the prior art. The display panel includes a red sub-pixel unit, a blue sub-pixel unit, and a green sub-pixel unit. The color filter 10 includes a red color filter unit 11 corresponding to the red sub-pixel unit, a blue color filter unit 12 corresponding to the blue sub-pixel unit, and a green color filter unit 13 corresponding to the green sub-pixel unit. Due to different colors of adjacent sub-pixel units in a horizontal direction, an overlapping region of two color filters can be set in an intersection area of the sub-pixel units to form a lateral light shielding region (such as an overlapping region 112 of the red color filter unit 11 and the blue color filter unit 12, etc.). Moreover, since the vertically adjacent sub-pixel units have a same color, a black matrix can only be set on an intersection area of the sub-pixel units to form a longitudinal light shielding region (such as an overlapping region 114 of the red color filter unit 11 and a red color filter unit 14, etc.).

In existing display panels, an overlapping region of the lateral light shielding region and the longitudinal light shielding region is provided with the color filter and the black matrix of two sub-pixel units, a height of the overlapping region is thus greater than that of other regions, which affects surface flatness of the display panel, thereby affecting diffusion uniformity of an alignment film in an alignment film process, and affecting quality of the display panel.

Accordingly, it is necessary to provide a color filter and a display panel to solve the technical problems in the prior art.

### SUMMARY OF THE DISCLOSURE

An object of the present disclosure is to provide a color filter and a display panel, by which a diffusion uniformity of an alignment film can be improved and quality of the display panel can be increased, so as to solve technical problem resulting from a poor diffusion uniformity of an alignment film, resulting in poor display quality of the display panel in the prior art color filter and display panel.

An embodiment of the present disclosure provides a color filter, including: a plurality of color filter units arranged in an array, where two laterally adjacent color filter units are different types, and two longitudinally adjacent color filter units are of a same type;

the color filter unit includes:

a display and light filtering region located on a center of the color filter unit, and the display and light filtering region including a corresponding color-filter photoresist layer;

a non-display and lateral light shielding region located on at least one lateral side of the color filter unit, where any one side of the non-display and lateral light shielding region is an overlapping region of the two laterally adjacent color filter units, and the non-display and lateral light shielding region includes two corresponding color-filter photoresist layers; and

a non-display and longitudinal light shielding region located on at least one longitudinal end of the color filter unit, where any one end of the non-display and longitudinal light shielding region is an overlapping region of the two longitudinally adjacent color filter units, and the non-display and longitudinal light shielding region includes at least one corresponding color-filter photoresist layer and a black matrix layer;

where an opening of photoresist layer in the overlapping region is formed on at least one side of the non-display and longitudinal light filtering region of the color filter unit for decreasing an area of the non-display and longitudinal light shielding region of two color-filter photoresist layers;

a lateral light shielding layer between two color filter units is formed by two color-filter photoresist layers of the non-display and lateral light shielding region corresponding to the two color filter units; and

a longitudinal light shielding layer between two color filter units is formed by the color-filter photoresist layer and the black matrix layer of the non-display and longitudinal light shielding region corresponding to the two color filter units.

In the color filter of the present disclosure, the overlapping region of the non-display and longitudinal light shielding region of same ends of two adjacent color filter units is disposed on the opening of photoresist layer in the overlapping region for decreasing the area of the non-display and longitudinal light shielding region of two color-filter photoresist layers of the overlapping region.

In the color filter of the present disclosure, the opening of photoresist layer in the overlapping region is a square or trapezoidal opening.

In the color filter of the present disclosure, a lateral length of the opening of photoresist layer in the overlapping region is slightly less than half of a lateral length of the non-display and lateral light shielding region.

In the color filter of the present disclosure, the color filter unit includes a red color filter unit, a green color filter unit, and a blue color filter unit.

An embodiment of the present disclosure provides a color filter, including: a plurality of color filter units arranged in an array, where two laterally adjacent color filter units are different types, and two longitudinally adjacent color filter units are of a same type;

the color filter unit includes:

a display and light filtering region located on a center of the color filter unit, and the display and light filtering region including a corresponding color-filter photoresist layer;

a non-display and lateral light shielding region located on at least one lateral side of the color filter unit, where any one side of the non-display and lateral light shielding region is an overlapping region of the two laterally adjacent color filter units, and the non-display and lateral light shielding region includes two corresponding color-filter photoresist layers; and

a non-display and longitudinal light shielding region located on at least one longitudinal end of the color filter unit, where any one end of the non-display and longitudinal light shielding region is an overlapping region of the two longitudinally adjacent color filter units, and the non-display and longitudinal light shielding region includes at least one corresponding color-filter photoresist layer and a black matrix layer; and

where an opening of photoresist layer in the overlapping region is formed on at least one side of the non-display and longitudinal light filtering region of the color filter unit for decreasing an area of the non-display and longitudinal light shielding region of two color-filter photoresist layers.

In the color filter of the present disclosure, a lateral light shielding layer between two color filter units is formed by two color-filter photoresist layers of the non-display and lateral light shielding region corresponding to the two color filter units.

In the color filter of the present disclosure, a longitudinal light shielding layer between two color filter units is formed by the color-filter photoresist layer and the black matrix layer of the non-display and longitudinal light shielding region corresponding to the two color filter units.

In the color filter of the present disclosure, the overlapping region of the non-display and longitudinal light shielding region of same ends of two adjacent color filter units is disposed on the opening of photoresist layer in the overlapping region for decreasing the area of the non-display and longitudinal light shielding region of two color-filter photoresist layers of the overlapping region.

In the color filter of the present disclosure, the opening of photoresist layer in the overlapping region is a square or trapezoidal opening.

In the color filter of the present disclosure, a lateral length of the opening of photoresist layer in the overlapping region is slightly less than half of a lateral length of the non-display and lateral light shielding region.

In the color filter of the present disclosure, the color filter unit includes a red color filter unit, a green color filter unit, and a blue color filter unit.

The present disclosure also provides a display panel, including: an array substrate, a second substrate corresponding to the array substrate, and a color filter disposed on the array substrate or the second substrate,

where the color filter includes a plurality of color filter units arranged in an array, where two laterally adjacent color filter units are different types, and two longitudinally adjacent color filter units are of a same type;

the color filter unit includes:

a display and light filtering region located on a center of the color filter unit, and the display and light filtering region including a corresponding color-filter photoresist layer;

a non-display and lateral light shielding region located on at least one lateral side of the color filter unit, where any one side of the non-display and lateral light shielding region is an overlapping region of the two laterally adjacent color filter units, and the non-display and lateral light shielding region includes two corresponding color-filter photoresist layers; and

a non-display and longitudinal light shielding region located on at least one longitudinal end of the color filter unit, where any one end of the non-display and longitudinal light shielding region is an overlapping region of the two longitudinally adjacent color filter units, and the non-display and longitudinal light shielding region includes at least one corresponding color-filter photoresist layer and a black matrix layer;

where an opening of photoresist layer in the overlapping region is formed on at least one side of the non-display and longitudinal light filtering region of the color filter unit for decreasing an area of the non-display and longitudinal light shielding region of two color-filter photoresist layers; and

the color filter units and pixel units of the display panel correspond to one another.

In the display panel of the present disclosure, a lateral light shielding layer between two color filter units is formed by two color-filter photoresist layers of the non-display and lateral light shielding region corresponding to the two color filter units.

In the display panel of the present disclosure, a longitudinal light shielding layer between two color filter units is formed by the color-filter photoresist layer and the black matrix layer of the non-display and longitudinal light shielding region corresponding to the two color filter units.

In the display panel of the present disclosure, the overlapping region of the non-display and longitudinal light shielding region of same ends of two adjacent color filter units is disposed on the opening of photoresist layer in the overlapping region for decreasing the area of the non-display and longitudinal light shielding region of two color-filter photoresist layers of the overlapping region.

In the display panel of the present disclosure, the opening of photoresist layer in the overlapping region is a square or trapezoidal opening.

In the display panel of the present disclosure, a lateral length of the opening of photoresist layer in the overlapping region is slightly less than half of a lateral length of the non-display and lateral light shielding region.

In the display panel of the present disclosure, the color filter unit includes a red color filter unit, a green color filter unit, and a blue color filter unit.

In the color filter and the display panel of the present disclosure, by setting the opening of photoresist layer in the overlapping region on the non-display and longitudinal light filtering region of the color filter unit, a surface flatness of the color filter of the display panel is increased, thereby increasing a diffusion uniformity of an alignment film of the display panel, and increasing quality of the display panel. Therefore, a technical problem resulting from the poor diffusion uniformity of the alignment film, which results in poor display quality of the display panel in the prior art color filter and display panel, is solved.

### BRIEF DESCRIPTION OF THE DRAWINGS

In order to more clearly describe the technical solutions of the embodiments of the present disclosure, accompanying drawings to be used in the detailed description of the disclosure will be briefly described hereinbelow. Obviously, the accompanying drawings described hereinbelow only illustrate some of the embodiments of the present disclosure, and those of ordinary skill in the art can also obtain other accompanying drawings therefrom without the need of making inventive efforts.

FIG.1 is a structural diagram of a color filter of a display panel in the prior art.

FIG. 2a is an exploded diagram of a color filter of a display panel of a first preferred embodiment of the present disclosure.

FIG. 2b is a structural diagram of the color filter of the display panel of the first preferred embodiment of the present disclosure.

FIG. 3a is an exploded diagram of a color filter of a display panel of a second preferred embodiment of the present disclosure.

FIG. 3b is a structural diagram of the color filter of the display panel of the second preferred embodiment of the present disclosure.

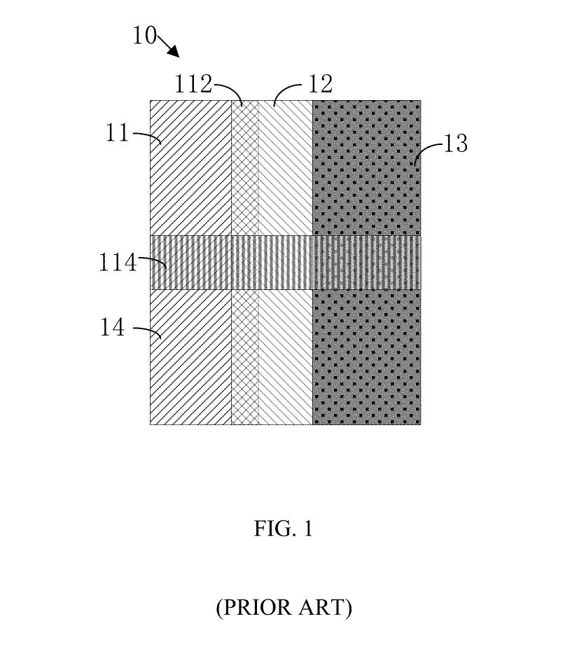

### DETAILED DESCRIPTION

The following clearly and completely describes the technical solutions in the embodiments of the present disclosure with reference to the accompanying drawings in the embodiments of the present disclosure. Apparently, the embodiments to be described are merely part rather than all of the embodiments of the present disclosure. All other embodiments obtained by persons of ordinary skill in the art based on the embodiments of the present disclosure without creative efforts shall fall within the protection scope of the present disclosure.

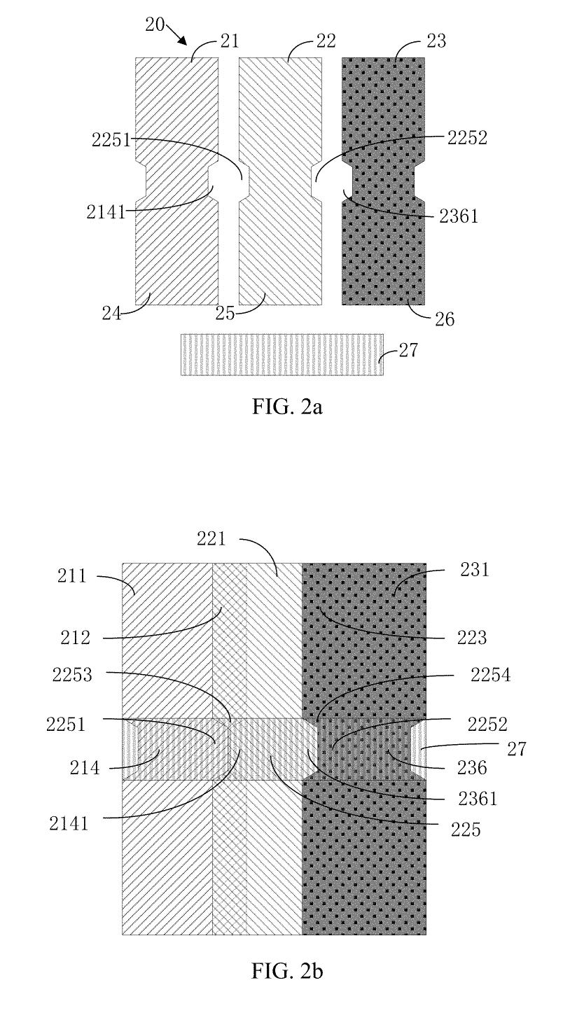

Refer to FIG. 2a and FIG. 2b, where FIG. 2a is an exploded diagram of a color filter of a display panel of a first preferred embodiment of the present disclosure, and FIG. 2b is a structural diagram of the color filter of the display panel of the first preferred embodiment of the present disclosure. A color filter 20 of the present disclosure includes a plurality of color filter units arranged in an array, where two laterally adjacent color filter units are different types, and two longitudinally adjacent color filter units are of a same type.

As shown in FIGS. 2a and 2b, the color filter 20 includes a red color filter unit 21, a green color filter unit 22, a blue color filter unit 23, a red color filter unit 24, a green color filter unit 25, and a blue color filter unit 26.

Each of the color filter units includes a display and light filtering region, a non-display and lateral light shielding region, and a non-display and longitudinal light shielding region.

The display and light filtering region located on a center of the color filter unit, and the display and light filtering region includes a corresponding color-filter photoresist layer. For example, a color-filter photoresist layer of a display and light filtering region 211 of the red color filter unit 21 is a red photoresist layer. A color-filter photoresist layer of a display and light filtering region 221 of the green color filter unit 22 is a green photoresist layer. A color-filter photoresist layer of a display and light filtering region 231 of the blue color filter unit 23 is a blue photoresist layer.

The non-display and lateral light shielding region is located on at least one lateral side of the color filter unit. Any one side of the non-display and lateral light shielding region is an overlapping region of the two laterally adjacent color filter units. The non-display and lateral light shielding region includes two corresponding color-filter photoresist layers.

For example, color-filter photoresist layers of a non-display and lateral light shielding region 212 of the red color filter unit 21 and the green color filter unit 22 are the red photoresist layer and the green photoresist layer. Color-filter photoresist layers of a non-display and lateral light shielding region 223 of the green color filter unit 22 and the blue color filter unit 23 are the green photoresist layer and the blue photoresist layer.

The non-display and longitudinal light shielding region is located on at least one longitudinal end of the color filter unit. Any one end of the non-display and longitudinal light shielding region is an overlapping region of the two longitudinally adjacent color filter units. The non-display and longitudinal light shielding region includes at least one corresponding color-filter photoresist layer and a black matrix layer.

For example, a color-filter photoresist layer of a non-display and longitudinal light shielding region 214 of the red color filter unit 21 and the red color filter unit 24 is the red photoresist layer. A color-filter photoresist layer of a non-display and longitudinal light shielding region 225 of the green color filter unit 22 and the green color filter unit 25 is the green photoresist layer. A color-filter photoresist layer of a non-display and longitudinal light shielding region 236 of the blue color filter unit 23 and the blue color filter unit 26 is the blue photoresist layer.

The lateral light shielding layer between two color filter units is formed by two color-filter photoresist layers of the non-display and lateral light shielding region corresponding to any two laterally adjacent color filter units. The longitudinal light shielding layer between two color filter units is formed by the color-filter photoresist layer and the black matrix layer of the non-display and longitudinal light shielding region corresponding to the two longitudinally adjacent color filter units.

For example, a lateral light shielding region between red color filter unit 21 and the green color filter unit 22 can be formed by the red photoresist layer and the green photoresist layer of the non-display and lateral light shielding region 212 of the red color filter unit 21 and the green color filter unit 22.

The longitudinal light shielding region of the green color filter unit 22 and the green color filter unit 25 is formed by the red photoresist layer, the green photoresist layer, the blue photoresist layer, and a black matrix layer 27 of the non-display and longitudinal light shielding region 225 of the green color filter unit 22 and the green color filter unit 25.

Therefore, different color light shielding units are divided by the lateral light shielding region and the longitudinal light shielding region, thereby preventing crosstalk from outgoing light from different pixel units.

In the present preferable embodiment, an opening of photoresist layer in the overlapping region is formed on at least one side of the non-display and longitudinal light filtering region of the color filter unit. Specifically, the opening of photoresist layer in the overlapping region is disposed on the overlapping region of the non-display and longitudinal light shielding region of a same end of two laterally adjacent color filter units, so as to decrease an area of the non-display and longitudinal light shielding region of the two color-filter photoresist layers in the overlapping region.

For example, an opening of photoresist layer in an overlapping region 2252 is formed on two sides of the non-display and longitudinal light filtering region 225 of the green color filter unit 22. An opening of photoresist layer in an overlapping region 2141 is formed on one side, which is near the green color filter unit 22, of the non-display and longitudinal light shielding region 214 of the red color filter unit 21. An opening of photoresist layer in an overlapping region 2361 is formed on one side, which is near the green color filter unit 22, of the non-display and longitudinal light filtering region 236 of the blue color filter unit 23.

In the present preferable embodiment, the opening of photoresist layer in the overlapping region is a square or trapezoidal opening. A lateral length of the opening of photoresist layer in the overlapping region is slightly less than half of a lateral length of the non-display and lateral light shielding region. Hence, there is only the red photoresist layer in a location of the opening of photoresist layer in the overlapping region 2251. There is only the blue photoresist layer in a location of the opening of photoresist layer in the overlapping region 2252. There is only the green photoresist layer in a location of the opening of photoresist layer in the overlapping region 2141. There is only the green photoresist layer in a location of the opening of photoresist layer in the overlapping region 2361.

An area of the non-display and longitudinal light shielding region 225 with both the red photoresist layer and the green photoresist layer is the same as a tiny area 2253 between the opening of photoresist layer in the overlapping region 2141 and the opening of photoresist layer in the overlapping region 2251. An area of the non-display and longitudinal light shielding region 225 with both the green photoresist layer and the blue photoresist layer is the same as a tiny area 2254 between the opening of photoresist layer in the overlapping region 2252 and the opening of photoresist layer in the overlapping region 2361.

Since there is only one color-filter photoresist layer and one black matrix layer at the opening of photoresist layer in the overlapping region 2251, the opening of photoresist layer in the overlapping region 2252, the opening of photoresist layer in the overlapping region 2141, and the opening of photoresist layer in the overlapping region 2361, and there is only one color-filter photoresist layer and one black matrix layer at the non-display and longitudinal light shielding region in addition to the tiny area 2253 and the tiny area 2254, the uniformity of the overall height of the non-display and longitudinal light shielding region is better. Moreover, since there are two color-filter photoresist layers at the non-display and lateral light shielding region, the uniformity of the overall height of the non-display and longitudinal light shielding region and the non-display and lateral light shielding region is also better. Therefore, the technical problem resulting from a height change of the lateral light shielding region and the longitudinal light shielding region is too large, so that a poor diffusion uniformity of an alignment film is solved, thereby increasing quality of the display panel.

In the present preferable embodiment, by setting the opening of photoresist layer in the overlapping region on the non-display and longitudinal light filtering region of the color filter unit, a surface flatness of the color filter of the display panel in increased, thereby increasing a diffusion uniformity of an alignment film of the display panel, and increasing quality of the display panel.

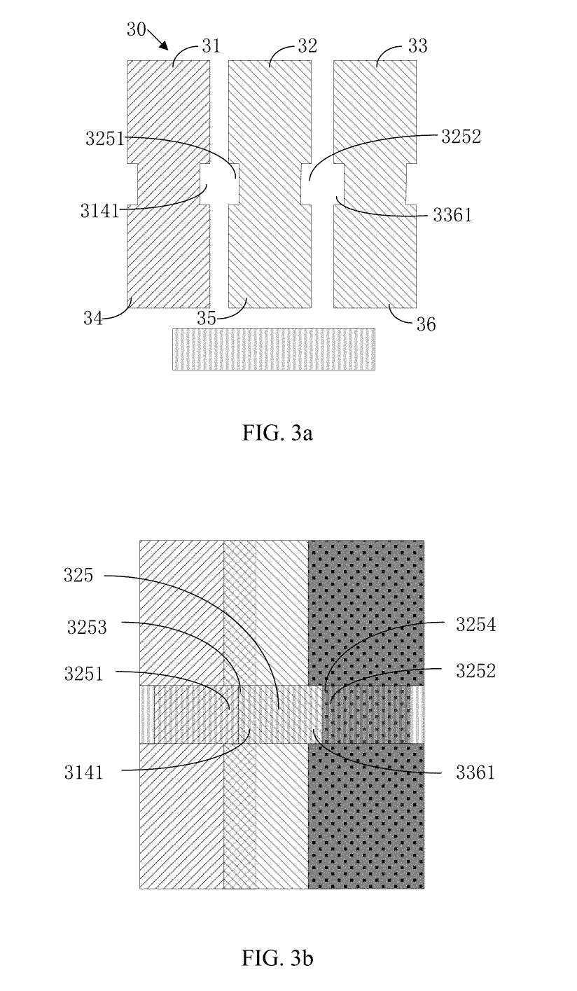

Refer to FIG. 3a and FIG. 3b, where FIG. 3a is an exploded diagram of a color filter of a display panel of a second preferred embodiment of the present disclosure, and FIG. 3b is a structural diagram of the color filter of the display panel of the second preferred embodiment of the present disclosure. In the preferable embodiment, a color filter 30 includes a red color filter unit 31, a green color filter unit 32, a blue color filter unit 33, a red color filter unit 34, a green color filter unit 35, and a blue color filter unit 36.

In the basic of the first preferred embodiment, the opening of photoresist layer in the overlapping region of the non-display and longitudinal light shielding region of the color filter unit of the color filter 30 of the preferred embodiment is a square opening. A lateral length of the opening of photoresist layer in the overlapping region is slightly less than half of a lateral length of the non-display and lateral light shielding region.

Thus, there is only the red photoresist layer in a location of the opening of photoresist layer in the overlapping region 3251. There is only the blue photoresist layer in a location of the opening of photoresist layer in the overlapping region 3252. There is only the green photoresist layer in a location of the opening of photoresist layer in the overlapping region 3141. There is only the green photoresist layer in a location of the opening of photoresist layer in the overlapping region 3361.

An area of the non-display and longitudinal light shielding region 325 with both the red photoresist layer and the green photoresist layer is the same as a tiny area 3253 between the opening of photoresist layer in the overlapping region 3141 and the opening of photoresist layer in the overlapping region 3251. An area of the non-display and longitudinal light shielding region 325 with both the green photoresist layer and the blue photoresist layer is the same as a tiny area 3254 between the opening of photoresist layer in the overlapping region 3252 and the opening of photoresist layer in the overlapping region 3361.

As can be seen from FIG. 3b, the tiny area 3253 and tiny area 3254 are further reduced, so that the uniformity of the overall height of the non-display and longitudinal light shielding region of the color filter unit of the color filter can be further improved, thereby increasing quality of the display panel.

The present disclosure also provides a display panel, which includes an array substrate, a second substrate corresponding to the array substrate, and a color filter disposed on the array substrate or the second substrate.

The color filter includes a plurality of color filter units arranged in an array, where two laterally adjacent color filter units are different types, and two longitudinally adjacent color filter units are of a same type.

Each of the color filter units includes a display and light filtering region, a non-display and lateral light shielding region, and a non-display and longitudinal light shielding region.

The display and light filtering region is located on a center of the color filter unit. The display and light filtering region includes a corresponding color-filter photoresist layer. The non-display and lateral light shielding region is located on at least one lateral side of the color filter unit, where any one side of the non-display and lateral light shielding region is an overlapping region of the two laterally adjacent color filter units, and the non-display and lateral light shielding region includes two corresponding color-filter photoresist layers. The non-display and longitudinal light shielding region is located on at least one longitudinal end of the color filter unit, where any one end of the non-display and longitudinal light shielding region is an overlapping region of the two longitudinally adjacent color filter units, and the non-display and longitudinal light shielding region includes at least one corresponding color-filter photoresist layer and a black matrix layer.

An opening of photoresist layer in the overlapping region is formed on at least one side of the non-display and longitudinal light filtering region of the color filter unit for decreasing an area of the non-display and longitudinal light shielding region of two color-filter photoresist layers. The color filter units and pixel units of the display panel correspond to one another.

Preferably, the lateral light shielding layer between two color filter units is formed by two color-filter photoresist layers of the non-display and lateral light shielding region corresponding to the two color filter units. The longitudinal light shielding layer between two color filter units is formed by the color-filter photoresist layer and the black matrix layer of the non-display and longitudinal light shielding region corresponding to the two color filter units.

Preferably, the overlapping region of the non-display and longitudinal light shielding region of the same ends of two adjacent color filter units is disposed on the opening of photoresist layer in the overlapping region for decreasing the area of the non-display and longitudinal light shielding region of two color-filter photoresist layers of the overlapping region.

The specific operation of the display panel of the present disclosure is the same as or similar to that described in the preferred embodiments of the above color filters, refer to the relevant description of the preferred embodiments of the color filters described above.

In the color filter and the display panel of the present disclosure, by setting the opening of photoresist layer in the overlapping region on the non-display and longitudinal light filtering region of the color filter unit, a surface flatness of the color filter of the display panel in increased, thereby increasing a diffusion uniformity of an alignment film of the display panel, and increasing the quality of the display panel. Therefore, a technical problem resulting from the poor diffusion uniformity of the alignment film, which results poor display quality of the display panel in the prior art color filter and display panel, is solved.

The above descriptions are merely preferable embodiments of the present disclosure, and are not intended to limit the scope of the present disclosure. Any modification or replacement made by those skilled in the art without departing from the spirit and principle of the present disclosure should fall within the protection scope of the present disclosure. Therefore, the protection scope of the present disclosure is subject to the appended claims.

What is claimed is:

1. A color filter, comprising: a plurality of color filter units arranged in an array, wherein two laterally adjacent color filter units are different types, and two longitudinally adjacent color filter units are of a same type;
the color filter unit comprises:
a display and light filtering region located on a center of the color filter unit, and the display and light filtering region comprising a corresponding color-filter photoresist layer;
a non-display and lateral light shielding region located on at least one lateral side of the color filter unit, wherein any one side of the non-display and lateral light shielding region is an overlapping region of the two laterally adjacent color filter units, and the non-display and lateral light shielding region comprises two corresponding color-filter photoresist layers; and
a non-display and longitudinal light shielding region located on at least one longitudinal end of the color filter unit, wherein any one end of the non-display and longitudinal light shielding region is an overlapping region of the two longitudinally adjacent color filter units, and the non-display and longitudinal light shielding region comprises at least one corresponding color-filter photoresist layer and a black matrix layer;
wherein an opening of photoresist layer in the overlapping region is formed on at least one side of the non-display and longitudinal light filtering region of the color filter unit for decreasing an area of the non-display and longitudinal light shielding region of two color-filter photoresist layers;
a lateral light shielding layer between two color filter units is formed by two color-filter photoresist layers of the non-display and lateral light shielding region corresponding to the two color filter units; and
a longitudinal light shielding layer between two color filter units is formed by the color-filter photoresist layer and the black matrix layer of the non-display and longitudinal light shielding region corresponding to the two color filter units.

2. The color filter as claimed in claim 1, wherein the overlapping region of the non-display and longitudinal light shielding region of same ends of two adjacent color filter units is disposed on the opening of photoresist layer in the overlapping region for decreasing the area of the non-display and longitudinal light shielding region of two color-filter photoresist layers of the overlapping region.

3. The color filter as claimed in claim 1, wherein the opening of photoresist layer in the overlapping region is a square or trapezoidal opening.

4. The color filter as claimed in claim 3, wherein a lateral length of the opening of photoresist layer in the overlapping region is slightly less than half of a lateral length of the non-display and lateral light shielding region.

5. The color filter as claimed in claim 1, wherein the color filter unit comprises a red color filter unit, a green color filter unit, and a blue color filter unit.

6. A color filter, comprising: a plurality of color filter units arranged in an array, wherein two laterally adjacent color filter units are different types, and two longitudinally adjacent color filter units are of a same type;
the color filter unit comprises:
a display and light filtering region located on a center of the color filter unit, and the display and light filtering region comprising a corresponding color-filter photoresist layer;
a non-display and lateral light shielding region located on at least one lateral side of the color filter unit, wherein any one side of the non-display and lateral light shielding region is an overlapping region of the two laterally adjacent color filter units, and the non-display and lateral light shielding region comprises two corresponding color-filter photoresist layers; and
a non-display and longitudinal light shielding region located on at least one longitudinal end of the color filter unit, wherein any one end of the non-display and longitudinal light shielding region is an overlapping region of the two longitudinally adjacent color filter units, and the non-display and longitudinal light shielding region comprises at least one corresponding color-filter photoresist layer and a black matrix layer; and
wherein an opening of photoresist layer in the overlapping region is formed on at least one side of the non-display and longitudinal light filtering region of the color filter unit for decreasing an area of the non-display and longitudinal light shielding region of two color-filter photoresist layers.

7. The color filter as claimed in claim 6, wherein a lateral light shielding layer between two color filter units is formed by two color-filter photoresist layers of the non-display and lateral light shielding region corresponding to the two color filter units.

8. The color filter as claimed in claim 6, wherein a longitudinal light shielding layer between two color filter units is formed by the color-filter photoresist layer and the black matrix layer of the non-display and longitudinal light shielding region corresponding to the two color filter units.

9. The color filter as claimed in claim 6, wherein the overlapping region of the non-display and longitudinal light shielding region of same ends of two adjacent color filter units is disposed on the opening of photoresist layer in the overlapping region for decreasing the area of the non-display and longitudinal light shielding region of two color-filter photoresist layers of the overlapping region.

10. The color filter as claimed in claim 6, wherein the opening of photoresist layer in the overlapping region is a square or trapezoidal opening.

11. The color filter as claimed in claim 10, wherein a lateral length of the opening of photoresist layer in the overlapping region is slightly less than half of a lateral length of the non-display and lateral light shielding region.

12. The color filter as claimed in claim 6, wherein the color filter unit comprises a red color filter unit, a green color filter unit, and a blue color filter unit.

13. A display panel, comprising: an array substrate, a second substrate corresponding to the array substrate, and a color filter disposed on the array substrate or the second substrate,
wherein the color filter comprises a plurality of color filter units arranged in an array, wherein two laterally adjacent color filter units are different types, and two longitudinally adjacent color filter units are of a same type;
the color filter unit comprises:
a display and light filtering region located on a center of the color filter unit, and the display and light filtering region comprising a corresponding color-filter photoresist layer;
a non-display and lateral light shielding region located on at least one lateral side of the color filter unit, wherein any one side of the non-display and lateral light shielding region is an overlapping region of the two laterally adjacent color filter units, and the non-display and lateral light shielding region comprises two corresponding color-filter photoresist layers; and
a non-display and longitudinal light shielding region located on at least one longitudinal end of the color filter unit, wherein any one end of the non-display and longitudinal light shielding region is an overlapping region of the two longitudinally adjacent color filter units, and the non-display and longitudinal light shielding region comprises at least one corresponding color-filter photoresist layer and a black matrix layer;
wherein an opening of photoresist layer in the overlapping region is formed on at least one side of the non-display and longitudinal light filtering region of the color filter unit for decreasing an area of the non-display and longitudinal light shielding region of two color-filter photoresist layers; and
the color filter units and pixel units of the display panel correspond to one another.

14. The display panel as claimed in claim 13, wherein a lateral light shielding layer between two color filter units is formed by two color-filter photoresist layers of the non-display and lateral light shielding region corresponding to the two color filter units.

15. The display panel as claimed in claim 13, wherein a longitudinal light shielding layer between two color filter units is formed by the color-filter photoresist layer and the black matrix layer of the non-display and longitudinal light shielding region corresponding to the two color filter units.

16. The display panel as claimed in claim 13, wherein the overlapping region of the non-display and longitudinal light shielding region of same ends of two adjacent color filter units is disposed on the opening of photoresist layer in the overlapping region for decreasing the area of the non-display and longitudinal light shielding region of two color-filter photoresist layers of the overlapping region.

17. The display panel as claimed in claim 13, wherein the opening of photoresist layer in the overlapping region is a square or trapezoidal opening.

18. The display panel as claimed in claim 17, wherein a lateral length of the opening of photoresist layer in the overlapping region is slightly less than half of a lateral length of the non-display and lateral light shielding region.

19. The display panel as claimed in claim 17, wherein the color filter unit comprises a red color filter unit, a green color filter unit, and a blue color filter unit.
